(19) United States
(12) Patent Application Publication
(10) Pub. No.: US 2010/0061205 A1
(43) Pub. Date: Mar. 11, 2010

(54) AN OPTICAL RECORDING APPARATUS

(75) Inventor: JAMES JOSEPH ANTHONY MCCORMACK, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 12/305,030

(22) PCT Filed: Jun. 5, 2007
(86) PCT No.: PCT/IB07/52100

§ 371 Date: Dec. 16, 2008

(30) Foreign Application Priority Data
Jun. 17, 2006 (EP) 06115633.7

(51) Int. Cl. G11B 20/10

(52) U.S. Cl. 369/47.28; G9B/20.009

(57) ABSTRACT

The present invention relates to an optical recording apparatus that provides improved writing speed. The apparatus has processing means (50) for processing an encoded data signal (NRZ) with a channel clock frequency signal (CLK). A first clock generator (52) derives a sub-sampled clock signal (CLKn) that has a lower frequency than the channel clock frequency signal (CLK). Furthermore, a modulator (MOD) modulates the sub-sampled clock signal (CLKn) with the encoded data signal (NRZ), and outputs a single, combined data and clock signal (NRZ_CLKn). This signal is received by the optical pick-up unit (OPU; 20), where a second clock generator (24) extracts a retrieved clock signal (CLKr) from the combined signal (NRZ_CLKn), and a data demodulator (23) extracts the encoded data signal (NRZ) using the retrieved clock signal (CLKr). Thereby, a fast and reliable bandwidth in the communication between the processing means and the optical pick-up (OPU; 20) is obtained.

The present invention relates to an optical recording apparatus, corresponding processing means for controlling an optical recording apparatus, and a corresponding method for operating an optical recording apparatus. In particular, the present invention provides improved writing speed for an optical recording apparatus.

An optical recording drive normally have a displaceable optical pick-up unit (OPU) positioned in opposed and proximate relationship to the optical disk. The OPU is then connected to a central digital signal processor (DSP) via a flexible signal transmission path section, also known in the art as the “flex” or “flex cable”. The path section may be a plurality of flat conducting lines sandwiched between two films or a set of collected coated flexible wires. The flex allows for sufficient displacement of the OPU while simultaneous keeping the OPU connected to the DSP. The DSP (or similar units) controls the operation of the OPU and feeds the OPU with encoded data and a clocking signal, see e.g. US patent application 2004/033814.

Within the optical pick-up unit (OPU), a laser is positioned for writing so that during optical recording of an optical disk or carrier, for rewriteable media, a laser beam is applied to selectively crystallize or make amorphous a phase-changing material in dependency of the data to be writing on the optical disk or carrier. Equally, for write-once media, a laser beam is applied to selectively to alter/burn away/deform (dye) material or not, in dependency of the data to be writing on the optical disk or carrier.

The laser is driven using a pulse form that contains higher frequency component than the channel rate itself. This has the form of a multi-level pulse with the purpose of writing a “mark” or a “space” at a given length in response to the encoded data. The conversion of encoded data, also known as no-return-to-zero data (NRZ), alternatively eight-to-fourteen modulated (EFM) data, to a pulse train with higher time resolution and multiple power levels is performed by a so-called write strategy generator (WSG) located on the OPU.

With the current trend of increasing writing speed to the optical disk, in particular for the Blu-Ray Disc (BD), the parallel transmission of encoded data and a clocking signal from the DSP to the OPU is approaching an upper limit. This is because the bandwidth of the flex is limited due to the usual physical design restrictions and length differences within the flex, additionally the variable flex position due to OPU movement (causing varying capacitive load) results in various frequency- and position dependent signal propagation delays in the transmitted data and/or the clock signal. Moreover, the encoded data needs a reliable set-up and hold time relative to the clocking signal. Estimates show that the BD 7× writing speed (500 MHz/2 nanoseconds) represents such an upper limit.

A solution for reducing the constraints imposed by the flex, and in turn increase the writing speed of the optical drive, is disclosed in WO 2005/001829. A signal containing data information and clock information is transferred over one common transfer path, i.e. flex, from an encoder to the OPU and a corresponding driver circuit. The driver circuit is arranged for generating a digital data signal and a digital clock signal from the single encoded signal received from the encoder. However, this solution requires that the encoder operates at the full clock frequency, because the coding method offered requires transmission of a code for every clock cycle in order to be successful in decoding (with EXOR gates, variable delays and flip-flops as mentioned).

The essence of the problem, with respect to WO 2005/001829, is that the channel bandwidth is finite. This means that every edge passes through the zero level and/or a level close to zero. These level(s) will almost invariably be used for data value. This has the result that the output of the decoder will produce false data levels during these times that cannot simply be solved. This applies to all conditions, and it is not handled explicitly in WO 2005/001829. Therefore, that solution is not an optimal solution for increasing the writing speed for an optical recording drive.

Hence, an improved optical recording apparatus would be advantageous, and in particular a more efficient and/or reliable optical recording apparatus would be advantageous.

Accordingly, the invention preferably seeks to mitigate, alleviate or eliminate one or more of the above mentioned disadvantages singly or in any combination. In particular, it may be seen as an object of the present invention to provide an optical recording apparatus that solves the above mentioned problems of the prior art with high speed writing.

This object and several other objects are obtained in a first aspect of the invention by providing an optical recording apparatus for recording information on an associated optical carrier, said apparatus comprising:

processing means arranged for processing at least partly an encoded data signal (NRZ) with a channel clock frequency signal (CLK), said processing means comprising:

a first clock generator capable of deriving a sub-sampled clock signal (CLKn) being of a lower frequency than said channel clock frequency signal (CLK), and

a modulator arranged for modulating said sub-sampled clock signal (CLKn) with the encoded data signal (NRZ) so as to output a single, combined data and clock signal (NRZ_CLKn), and

an optical pick-up unit (OPU) comprising an irradiation source and a corresponding drive device (LDD), said optical pick-up unit (OPU) being operably connected to the processing means for receiving said combined signal (NRZ_CLKn), said drive device comprising:
a second clock generator capable of extracting a retrieved clock signal (CLKr) from the combined signal (NRZ_CLKn), and

a data demodulator capable of extracting said encoded data signal (NRZ) using said retrieved clock signal (CLKr).

The invention is particularly, but not exclusively, advantageous for obtaining an optical drive or optical recording apparatus that is capable of having a fast and reliable bandwidth in the communication between the processing means of the optical recording apparatus and the optical pick-up (OPU) of the optical recording apparatus. In particular, for writing information with in a Blu-Ray disk system, the present invention provides a superior solution relative to the hitherto known solutions in the prior art. The present invention is considered an important milestone on the way towards 12× BD writing and above. The nature of the single asynchronous solution for the clock and data transmission provides a range of advantages relative to a parallel synchronous solution, which is normally applied in the present optical recording systems. While WO 2005/001829 suggests an alternative single asynchronous solution for the clock and data transmission to the optical pick-up unit (OPU), the solutions of that disclosure do not gain the full potential of the single asynchronous solution for the clock and data transmission due to the restrictions imposed in WO 2005/001829 as discussed above.

In one embodiment, the drive device (LDD) may be operably connected to the processing means through a single electrical conductor means arranged for transmitting the single, combined signal (NRZ_CLK). Thus, the combined signal (NRZ_CLKn) can have one dedicated connection in a common flexible transfer path, i.e. the flex; however, other control signals are transmitted in the flex as well.

Advantageously, the drive device (LDD) may further comprise resampling means arranged for resampling, and outputting the encoded data signal (NRZ) in order to improved the quality of the data signal (NRZ). Additionally or alternatively, the data demodulator may further comprise signal conditioning means adapted for reconditioning the encoded data signal.

Beneficially, the second clock generator may be adapted for retrieving substantially the channel clock frequency signal (CLK). Thus, as a supplement or a replacement for the retrieved clock signal (CLKr) the channel clock frequency signal (CLK), or any derivatives thereof, may be retrieved in order to improve processing on the optical pick-up. This can be performed by e.g. phase lock loop (PLL) detection means or the like.

Beneficially, the frequency of the sub-sampled clock signal (CLKn) times an integer (n) may be substantially equal to the frequency of the channel clock frequency signal (CLK). Thus, by frequency dividing means, the sub-sampled clock signal (CLKn) can be derived from the frequency of the channel clock frequency signal (CLK) facilitating a relatively simple implementation of this embodiment.

Preferably, the modulator may be a digital multiplier or the like in order to provide a relatively simple implementation of the present invention. Possibly, a multiplier with e.g. 4-state output may be implemented.

In one embodiment, the data demodulator may comprise a plurality of parallel demodulating sub-units, and the resampling means comprises a corresponding plurality of resampling sub-units, said sub-units being collectively arranged to demodulate and resample a plurality (m) of encoded data channels. Additionally, each of the encoded data channels of the plurality (m) of encoded data channels may be assigned to a separate phase of the main clock frequency (CLK). This allows for parallel processing of encoded data in the OPU at lower frequency than otherwise feasible.

Beneficially, the optical recording apparatus may be further adapted to adjust the resampling in response to a detected error in the encoded data signal (NRZ) so as to improve the quality of the data signal (NRZ). This may be done in an iterative manner based on data being resampled, and/or based on the pre-defined test signal being transmitted prior to writing and/or during an intermission of the writing process.

In a second aspect, the present invention relates to processing means for controlling an associated optical recording apparatus for recording information on an associated optical carrier, the processing means being arranged for processing at least partly an encoded data signal (NRZ) with a channel clock frequency signal (CLK), said processing means comprising:

a first clock generator capable of deriving a sub-sampled clock signal (CLKn) being of a lower frequency than said channel clock frequency signal (CLK), and

a modulator arranged for modulating said sub-sampled clock signal (CLKn) with the encoded data signal (NRZ) so as to output a single, combined data and clock signal (NRZ_CLKn).

In a third aspect, the present invention relates to a method for operating an optical recording apparatus for recording information on an optical carrier, the method comprising the steps of:

processing by processing means at least partly an encoded data signal (NRZ) with a channel clock frequency signal (CLK),

deriving by a first clock generator a sub-sampled clock signal (CLKn) being of a lower frequency than said channel clock frequency signal (CLK), and

modulating by a modulator the sub-sampled clock signal (CLKn) with the encoded data signal (NRZ) so as to output a single, combined data and clock signal (NRZ_CLKn), and

extracting by a second clock generator in an optical pick-up unit (OPU) a retrieved clock signal (CLKr) from the combined signal (NRZ_CLKn), and

extracting by a data demodulator said encoded data signal (NRZ) using said retrieved clock signal (CLKr).

In a fourth aspect, the invention relates to a computer program product being adapted to enable a computer system comprising at least one computer having data storage means associated therewith to control an optical recording apparatus according to the third aspect of the invention.

This aspect of the invention is particularly, but not exclusively, advantageous in that the present invention may be implemented by a computer program product enabling a computer system to perform the operations of the second aspect of the invention. Thus, it is contemplated that some known an optical recording apparatus may be changed to operate according to the present invention by installing a computer program product on a computer system controlling the said optical recording apparatus. Such a computer program product may be provided on any kind of computer readable medium, e.g. magnetically or optically based medium, or through a computer based network, e.g. the Internet.

The first, second, third and fourth aspect of the present invention may each be combined with any of the other aspects. These and other aspects of the invention will be apparent from and elucidated with reference to the embodiments described hereinafter.

The present invention will now be explained, by way of example only, with reference to the accompanying Figures, where

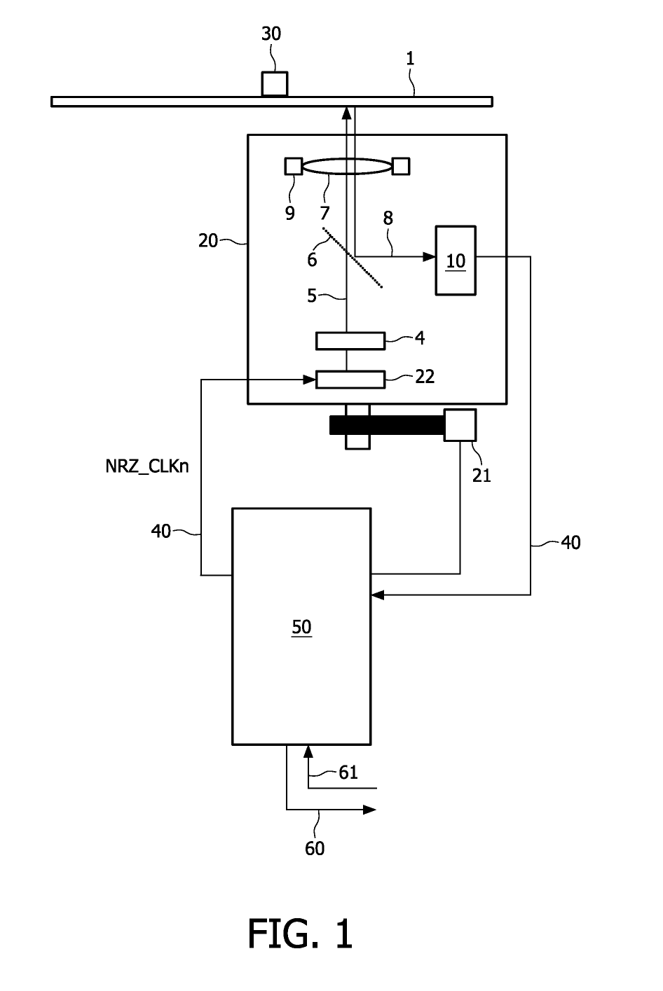

FIG. 1 schematically shows an optical recording apparatus or drive and an optical information carrier according to the present invention,

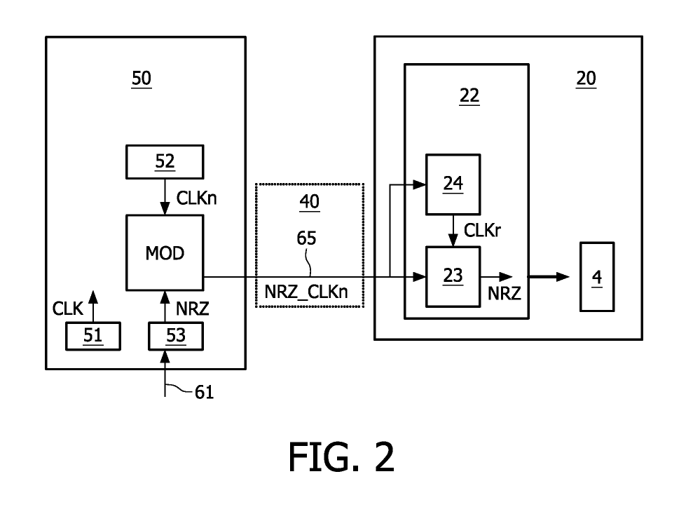

FIG. 2 schematically shows the processing means, the optical pick-up unit (OPU), and the flexible transmission path connecting the processing means and the optical pick-up unit (OPU) according to the invention,

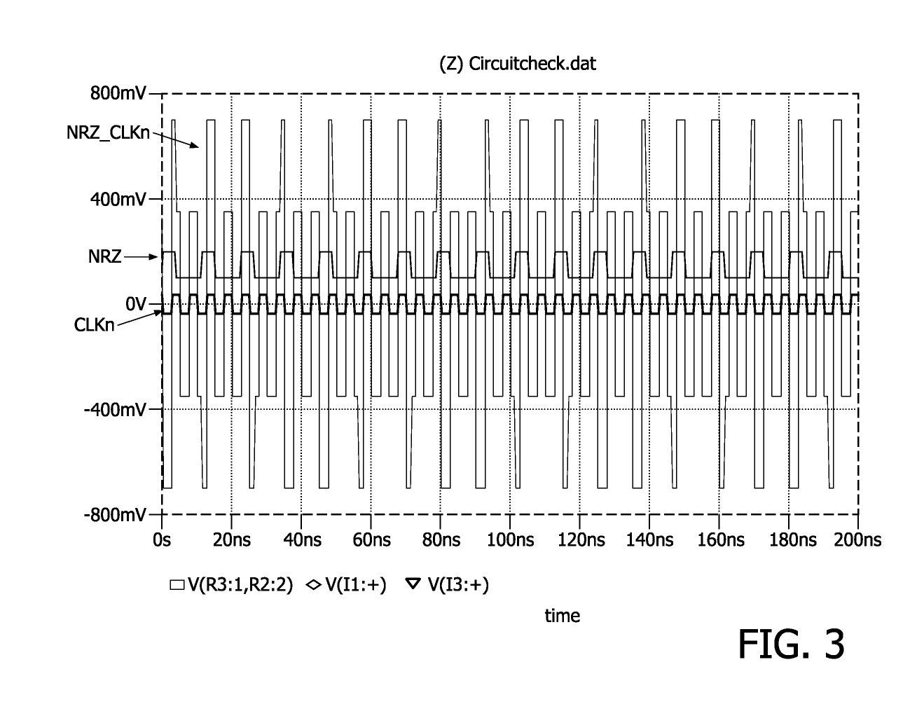

FIG. 3 shows how the sub-sampled clock signal is modulated with the encoded data signal (NRZ) resulting in a single, combined signal according to the present invention,

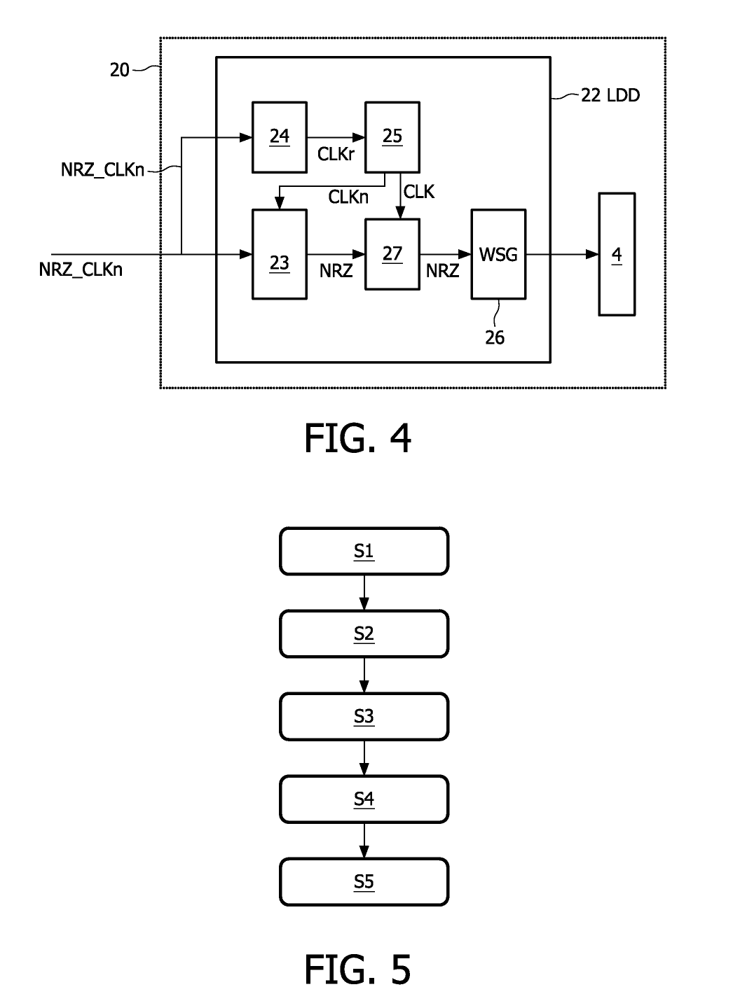

FIG. 4 schematically shows an embodiment of the optical pick-up unit (OPU) according to the present invention, and

FIG. 5 is a flow-chart of a method according to the invention.

FIG. 1 shows an optical recording apparatus or drive and an optical information carrier 1 according to the invention. The carrier 1 is fixed and rotated by holding means 30.

The carrier 1 comprises a material suitable for recording information by means of a radiation beam 5. The recording material may, for example, be of the magneto-optical type, the phase-change type, the dye type, metal alloys like Cu/Si or any other suitable material. Information may be recorded in the form of optically detectable effects, also called “marks” for rewriteable media and “pits” for write-once media, on the optical carrier 1.

The optical apparatus, i.e. the optical drive, comprises an optical head 20, sometimes called an optical pick-up (OPU), the optical head 20 being displaceable by actuation means 21, e.g. an electric stepping motor. The optical head 20 comprises a photo detection system 10, a laser driver device 30, a radiation source 4, a beam splitter 6, an objective lens 7, and lens displacement means 9 capable of displacing the lens 7 both in a radial direction of the carrier 1 and in the focus direction.

The function of the photo detection system 10 is to convert radiation 8 reflected from the carrier 1 into electrical signals. Thus, the photo detection system 10 comprises several photo detectors, e.g. photodiodes, charged-coupled devices (CCD), etc., capable of generating one or more electric output signals. The photo detectors are arranged spatially to one another and with a sufficient time resolution so as to enable detection of error signals, i.e. focus error FE and radial tracking error RE. The focus error FE and radial tracking error RE signals are transmitted to the processor 50 where a commonly known servomechanism operated by using of PID control means (proportional-integrate-differentiate) is applied for controlling the radial position and focus position of the radiation beam 5 on the carrier 1.

The radiation source 4 for emitting a radiation beam or a light beam 5 can for example be a semiconductor laser with a variable power, possibly also with variable wavelength of radiation. Alternatively, the radiation source 4 may comprise more than one laser. In the context of the present invention the term “light” is considered to comprise any kind of electromagnetic radiation suitable for optical recording and/or reproduction, such as visible light, ultraviolet light (UV), infrared light (IR), etc.

The radiation source 4 is controlled by the laser driver device (LD) 22. The laser driver (LD) 22 comprises electronic circuitry means (not shown in FIG. 1) for providing a drive current to the radiation source 4 in response to a single, combined data and clock signal NRZ_CLKn transmitted from the processor 50 through the common transfer path 40, i.e. the flex.

The processor 50 also receives and analyses signals from the photo detection means 10 through the common transfer path 40. The processor 50 can also output control signals to the actuation means 21, the radiation source 4, the lens displacement means 9, and the rotating means 30, as schematically illustrated in FIG. 1. Similarly, the processor 50 can receive data to be written, indicated at 61, and the processor 50 may output data from the reading process as indicated at 60. While the processor 50 has been depicted as a single unit in FIG. 1, it is to be understood that equivalently the processor 50 may be a plurality of interconnecting processing units positioned in the optical recording apparatus, possibly some of the units may be positioned in the optical head 20.

FIG. 2 schematically shows in more detail the processing means 50, the optical pick-up unit (OPU) 20, and the flexible transmission path 40 (the “flex”) connecting the processing means 50 and the optical pick-up unit (OPU) 20.

The processing means 50 receives data 61 to be written on the optical carrier 1 (not shown in FIG. 2). The data is initially encoded by a conventional encoder 53. The encoding is performed according to the appropriate format of the carrier 1.

Data recording on various carrier formats, such as the compact disc (CD) format, the digital versatile disc (DVD), and the Blu-Ray disc (BD), is performed by encoding the data 61 according to a standard encoding scheme to obtain a NRZ signal to be transmitted to the optical head 20 for writing. In the table below, corresponding carrier formats and encoding schemes are listed:

| Carrier formats | Encoding scheme |
|---|---|
| CD | 2,10 EFM |
| DVD | 2,10 EFM+ |
| BD | 1,7 PP |

EFM is the commonly known abbreviation for Eight-to-Fourteen Modulation, and PP is an abbreviation for partial product. The present invention is not limited to the above listed carrier formats. Rather, the invention is particularly suited for obtaining high writing speeds on optical carriers in general.

The processing means 50 is operated, at least in some sub-areas and/or for some procedures, at a certain clock frequency given by a channel clock frequency signal CLK or derivates thereof (e.g. at half or a quarter of the channel clock frequency). For e.g. a Blu-Ray disk (BD) being written at 1×, this frequency is approx. 66 MHz. For 2× writing it is 132 MHz and so forth.

The processing means 50 further comprises a first clock generator 52 capable of deriving a sub-sampled clock signal CLKn being of a lower frequency than said main clock frequency CLK. The sub-sampled signal CLKn is preferably derived from the main clock signal CLK by e.g. frequency division. Thus, the frequency of the sub-sampled signal CLKn times an integer n (or possibly a non-integer constant) can be substantially equal to the frequency of the main clock signal CLK. More specifically, the integer n could be 2, 3, 4, 5, 6, 7, 8, 9, 10, 11, 12, 13, 14, 15, 16, 17, 18, 19, or 20 or even higher. In that respect, the meaning of the term “clock generator” may be taken to include a frequency divider or similar circuits.

The frequency of the sub-sampled signal CLKn could, e.g. for Blu-Ray Disc (BD) writing, be in the interval from 50-500 MHz, or 100-400 MHz, or alternatively 200-300 MHz. The frequency of the sub-sampled signal CLKn could in another embodiment be limited to a maximum of 1000 MHz, 900 MHz, 800 MHz, 700 MHz, 600 MHz, 500 MHz, 400 MHz, 300 MHz, 250 MHz, 200 MHz, 150 MHz, or 100 MHz. In particular, the frequency of the clock signal CLK and/or the combined signal NRZ_CLKn can be set below the frequency bandwidth of the flex 40 so as to obtain substantially undistorted transmission to the OPU 20. With the present flex cable technology, this limit is around 150 MHz to 200 MHz.

A modulator MOD is arranged for modulating the sub-sampled clock signal CLKn with the encoded data signal NRZ so as to output a single, combined data and clock signal NRZ_CLKn. This can be done by a digital multiplier or other modulation means readily available to the skilled person once the general principle of the present is acknowledged.

FIG. 3 shows how the sub-sampled clock signal CLKn is modulated with the encoded data signal NRZ resulting in a single, combined signal NRZ_CLKn by using a digital multiplier as a modulator MOD.

As shown in FIG. 2, the single, combined signal NRZ_CLKn transmitted to the optical pick-up unit (OPU) 20. The unit 20 comprises an irradiation source 4 and a corresponding drive device (LDD) 22 operably connected to the processing means 50 for receiving said combined signal NRZ_CLKn through the common transfer path 40, i.e. the flex, where a single electrical conductor means 65 is arranged for transmitting the single, combined signal NRZ_CLKn. In this embodiment, just one connection 65 is shown in a flex; however other control signals are also transmitted in the path 40 as explained in connection with the above description of FIG. 1 above.

The drive device (LDD) 22 comprises a second clock generator 24 capable of extracting a retrieved clock signal CLKr from the combined signal NRZ_CLKn, and a data demodulator 23 capable of extracting the encoded data signal NRZ using said retrieved clock signal CLKr, which is shown in FIG. 2 to be transmitted to the demodulator 23 from the second clock generator 24. The encoded data signal NRZ is then processed and used to control the irradiation source 4 by e.g. application of a write strategy as will be explained below in more detail in connection with FIG. 4 below.

FIG. 4 schematically shows an embodiment of the optical pick-up unit (OPU) 20, where the second clock generator 24 transmits the retrieved clock signal CLKr to a phase lock loop circuit (PLL) 25 adapted to extract the substantially sub-sampled clock signal CLKn again, and possibly the main clock signal CLK. The sub-sampled clock signal CLKn is applied by the demodulator 23 for extracting the encoded signal NRZ. In order to further improve the encoded signal NRZ, signal conditioning can be applied before outputting the NRZ data from the demodulator 23. Additionally, the NRZ data signal is transmitted to the resampling means 27, where the NRZ data signal is further optimized by resampling using the main clock signal CLK received by the resampling means 27 from the phase lock loop (PLL) circuit 25. Resampling can be performed by e.g. flip-flop devices as shown e.g. in WO 2005/001829 (to the same applicant), which is hereby included by reference in its entirety. Resampling can include signal and/or amplitude off-setting, followed by clipping and bottoming of the signal. Subsequently, the resampled NRZ data signal is sent to the write strategy generator (WSG) 26 for processing of a corresponding write pulse train to the irradiation source 4.

Additionally, the NRZ data signal is transmitted to resampling means 27, where the NRZ data signal is further optimized by resampling using the main clock signal CLK received by the resampling means 27 from the phase lock loop (PLL) circuit 25. Subsequently, the resampled NRZ data signal is sent to the write strategy generator (WSG) 26 for processing of a corresponding write pulse train to the irradiation source 4.

In one embodiment of the invention which is not illustrated in FIG. 4, the data demodulator 23 comprises a plurality of parallel demodulating sub-units, and the resampling means 27 comprises a corresponding plurality of resampling sub-units, where both types of sub-units are collectively arranged to demodulate and resample a plurality m of encoded data channels. Thus, the data demodulator 23 can additionally function as a demultiplexer. Advantageously, each of the encoded data channels of the plurality m of encoded data channels is assigned a separate phase of the main clock frequency CLK. This allows parallel processing in the OPU 20 at a lower frequency than the frequency of the main clock signal CLK. Accordingly, the write strategy generator 26 is adapted for processing an incoming NRZ data stream organized in a parallel of m data channels.

FIG. 5 is a flow-chart of a method according to the invention, the method comprising the steps of:

S1 processing by processing means (50) at least partly an encoded data signal (NRZ) with a channel clock frequency signal (CLK),

S2 deriving by a first clock generator (52) a sub-sampled clock signal (CLKn) being of a lower frequency than said channel clock frequency signal (CLK), and

S3 modulating by a modulator (MOD) the sub-sampled clock signal (CLKn) with the encoded data signal (NRZ) so as to output a single, combined data and clock signal (NRZ_CLKn),

S4 extracting by a second clock generator (24) in an optical pick-up unit (OPU; 20) a retrieved clock signal (CLKr) from the combined signal (NRZ_CLKn), and

S5 extracting by a data demodulator (23) said encoded data signal (NRZ) using said retrieved clock signal (CLKr).

Although the present invention has been described in connection with the specified embodiments, it is not intended to be limited to the specific form set forth herein. Rather, the scope of the present invention is limited only by the accompanying claims. In the claims, the term “comprising” does not exclude the presence of other elements or steps. Additionally, although individual features may be included in different claims, these may possibly be advantageously combined, and the inclusion in different claims does not imply that a combination of features is not feasible and/or advantageous. In addition, singular references do not exclude a plurality. Thus, references to “a”, “an”, “first”, “second” etc. do not preclude a plurality. Furthermore, reference signs in the claims shall not be construed as limiting the scope.

1. An optical recording apparatus for recording information on an associated optical carrier (1), said apparatus comprising:
processing means (50) arranged for processing at least partly an encoded data signal (NRZ) with a channel clock frequency signal (CLK), said processing means comprising:
a first clock generator (52) capable of deriving a sub-sampled clock signal (CLKn) being of a lower frequency than said channel clock frequency signal (CLK), and
a modulator (MOD) arranged for modulating said sub-sampled clock signal (CLKn) with the encoded data signal (NRZ) so as to output a single, combined data and clock signal (NRZ_CLKn), and
an optical pick-up unit (OPU; 20) comprising an irradiation source (4) and a corresponding drive device (LDD; 22), said optical pick-up unit (OPU; 20) being operably connected to the processing means (50) for receiving said combined signal (NRZ_CLKn), said drive device comprising:
a second clock generator (24) capable of extracting a retrieved clock signal (CLKr) from the combined signal (NRZ_CLKn), and
a data demodulator (23) capable of extracting said encoded data signal (NRZ) using said retrieved clock signal (CLKr).

2. An apparatus according to claim 1, wherein the drive device (LDD; 22) is operably connected to the processing means (50) through a single electrical conductor means arranged for transmitting the single, combined signal (NRZ_CLK).

3. An apparatus according to claim 1, wherein the drive device (LDD; 22) further comprises resampling means (27) arranged for resampling, and outputting the encoded data signal (NRZ).

4. An apparatus according to claim 1, wherein the data demodulator (23) further comprises signal conditioning means adapted for reconditioning the encoded data signal (NRZ).

5. An apparatus according to claim 1, wherein the second clock generator (24) is adapted for retrieving substantially the channel clock frequency signal (CLK).

6. An apparatus according to claim 1, wherein the modulator (MOD) is a digital multiplier.

7. An apparatus according to claim 3, wherein the data demodulator (23) comprises a plurality of parallel demodulating sub-units, and the resampling means (27) comprises a corresponding plurality of resampling sub-units, said sub-units being collectively arranged to demodulate and resample a plurality (m) of encoded data channels.

8. An apparatus according to claim 5, wherein each of the encoded data channels of the plurality (m) of encoded data channels is assigned to a separate phase of the main clock frequency (CLK).

9. An apparatus according to claim 1, wherein the frequency of the sub-sampled clock signal (CLKn) times an integer (n) is substantially equal to the frequency of the channel clock frequency signal (CLK).

10. An apparatus according to claim 3, wherein the apparatus is further adapted to adjust the resampling in response to a detected error in the encoded data signal (NRZ).

11. Processing means (50) for controlling an associated optical recording apparatus for recording information on an associated optical carrier (1), the processing means being arranged for processing at least partly an encoded data signal (NRZ) with a channel clock frequency signal (CLK), said processing means comprising:
a first clock generator (52) capable of deriving a sub-sampled clock signal (CLKn) being of a lower frequency than said channel clock frequency signal (CLK), and
a modulator (MOD) arranged for modulating said sub-sampled clock signal (CLKn) with the encoded data signal (NRZ) so as to output a single, combined data and clock signal (NRZ_CLKn).

12. A method for operating an optical recording apparatus for recording information on an optical carrier (1), the method comprising the steps of:
processing by processing means (50) at least partly an encoded data signal (NRZ) with a channel clock frequency signal (CLK),
deriving by a first clock generator (52) a sub-sampled clock signal (CLKn) being of a lower frequency than said channel clock frequency signal (CLK), and
modulating by a modulator (MOD) the sub-sampled clock signal (CLKn) with the encoded data signal (NRZ) so as to output a single, combined data and clock signal (NRZ_CLKn),
extracting by a second clock generator (24) in an optical pick-up unit (OPU; 20) a retrieved clock signal (CLKr) from the combined signal (NRZ_CLKn), and
extracting by a data demodulator (23) said encoded data signal (NRZ) using said retrieved clock signal (CLKr).

14. A computer program product being adapted to enable a computer system comprising at least one computer having data storage means associated therewith to control an optical recording apparatus according to claim 12.
